(19) United States
(12) Patent Application Publication
(10) Pub. No.: US 2026/0081485 A1
(43) Pub. Date: Mar. 19, 2026

(54) FASTENING OF AN AXIAL-FLUX ELECTRIC MOTOR STATOR

(71) Applicant: SAFRAN LANDING SYSTEMS, VELIZY-VILLACOUBLAY (FR)

(72) Inventors: Bertrand DUBACHER, MOISSY-CRAMAYEL (FR); Bertrand EUZET, MOISSY-CRAMAYEL (FR); Duy-Minh NGUYEN, MOISSY-CRAMAYEL (FR)

(73) Assignee: SAFRAN LANDING SYSTEMS, VELIZY-VILLACOUBLAY (FR)

(21) Appl. No.: 18/868,522

(22) PCT Filed: May 23, 2023
(86) PCT No.: PCT/EP2023/063745

§ 371 Date: Nov. 22, 2024

(30) Foreign Application Priority Data
May 23, 2022 (FR) FR2204941

(51) Int. Cl. H02K 1/18; B64C 25/24; H02K 1/14; H02K 1/2796; H02K 21/24

(52) U.S. Cl. CPC H02K 1/182; B64C 25/24; H02K 1/146; H02K 1/2796; H02K 21/24

(57) ABSTRACT

An electric motor having a casing inside which there is mounted at least one stator and a rotor that can rotate about an axis opposite the stator, the rotor having magnetic poles and the stator having a ferromagnetic yoke that bears windings arranged to produce, together with the magnetic poles of the rotor, an axial flux electric motor. The stator can be fixed in place relative to the casing by a fastening device which includes lugs projecting radially from a surface of the yoke, and at least one fastening element that is fastened to the casing and arranged to interact with the lugs so as to lock the stator along and around the axis.

The present invention relates to the field of electric motors, in particular to fastening a stator of an axial flux electric motor.

### BACKGROUND OF THE INVENTION

A radial flux synchronous electric motor conventionally comprises a rotor rotatably mounted inside a stator that is fastened to a casing by shrink-fitting or by means of screws passing through the casing. The stator generally comprises a laminated core forming a yoke, and a plurality of teeth that extend radially about the axis of rotation of the rotor and on which there are wound windings that are capable of interacting with permanent magnets borne by the rotor for rotating said rotor.

In an axial flux electric motor, the rotor does not extend inside a stator but is, for example, sandwiched between two stators extending symmetrically on either side of the rotor. The laminated core of each stator then forms axially extending teeth on which the windings interacting with the permanent magnets of the rotor are wound. Shrink-fitting the stators is not possible.

One solution involves screwing the stators to a casing of the motor by means of screws passing through said casing. However, fastening the stators in this way creates problems as regards the sealing of the casing in particular, and involves tapping or adding inserts in the stator yokes, which can lead to separation of the laminated cores forming said stator yokes.

Another solution involves screwing bars that extend radially between two teeth. However, fastening the stators in this manner requires the following in particular:
the height of the teeth has to be increased to limit the magnetic imbalances generated by the body of the bars; this increases the mass of the stator and therefore of the motor;
the bars have to be put in position before the windings to limit the deterioration and impregnation of the windings, making it complicated to disassemble said bars; and
the screws for fastening the bars have to be placed far enough away from the windings to limit dielectric issues and difficulties in passing through the windings, which increases the mass of the stator and therefore of the motor.

### OBJECT OF THE INVENTION

The object of the invention is therefore to propose a device for fastening a stator of an axial flux electric motor that overcomes at least some of the above-mentioned disadvantages.

### SUMMARY OF THE INVENTION

To this end, an electric motor is proposed, comprising a casing inside which there are mounted at least one stator and a rotor that can rotate about an axis opposite the stator, the rotor having magnetic poles and the stator comprising a ferromagnetic yoke that bears windings arranged to produce, together with the magnetic poles of the rotor, an axial flux electric motor.

According to the invention, the stator is fixed in place relative to the casing by means of a fastening device which comprises lugs projecting radially from a surface of the yoke, and at least one fastening element that is fastened to the casing and arranged to interact with the lugs so as to lock the stator along and around the axis.

A fastening device of this kind allows the stator to be fitted from the inside without causing any casing sealing issues and while limiting the weight of the motor.

In particular, the lugs project from an inner surface of the yoke.

In particular, the motor comprises pins which are inserted into holes, which are made in the yoke, and have an end portion projecting radially from the surface of said yoke to form the lugs.

In particular, the lugs are evenly angularly distributed about the axis.

In particular, the yoke of the stator is generally annular in shape and comprises a plurality of teeth around which the windings are wound, the lugs extending away from the teeth.

According to a particular embodiment, the fastening device comprises a single fastening element comprising a flange which comprises a plate provided with bayonet fastening notches suitable for receiving receive the lugs.

In particular, the plate comprises an outer cylindrical bearing surface arranged to interact with a corresponding bearing surface formed by an inner surface of the stator.

According to another particular embodiment, the fastening device comprises a plurality of fastening elements, each fastening element comprising a screw which passes through the casing and is screwed into a thread provided in one of the lugs along the axis.

In particular, the motor comprises two identical stators extending symmetrically on either side of the rotor.

The invention also relates to an aircraft comprising at least one landing gear which comprises a strut mounted on a structure of the aircraft so as to be pivotable between a deployed position and a retracted position by means of an electric motor of the aforementioned kind.

### BRIEF DESCRIPTION OF THE DRAWINGS

The invention will be better understood in the light of the following description, which is purely illustrative and non-limiting and should be read with reference to the accompanying drawings, in which:

FIG. 1 is a schematic view of an aircraft provided with an electric motor according to a particular embodiment of the invention;

FIG. 2 is an exploded view of the electric motor shown in FIG. 1;

FIG. 3 is a perspective view of the rotor of the electric motor shown in FIG. 2;

FIG. 4A is a perspective view of one of the stators of the electric motor shown in FIG. 2, with no winding;

FIG. 4B is a view of a detail of the stator shown in FIG. 4A, provided with windings;

FIG. 5 is a perspective view of the plate for fastening the stator shown in FIGS. 4A-4B;

FIG. 6A is a view of a detail of the stator shown in FIG. 4A, in which the stator is in an insertion position;

FIG. 6B is an identical view to FIG. 6A in which the stator is in an unlocked position;

FIG. 6C is an identical view to FIG. 6A in which the stator is in a locked position.

### DETAILED DESCRIPTION OF THE INVENTION

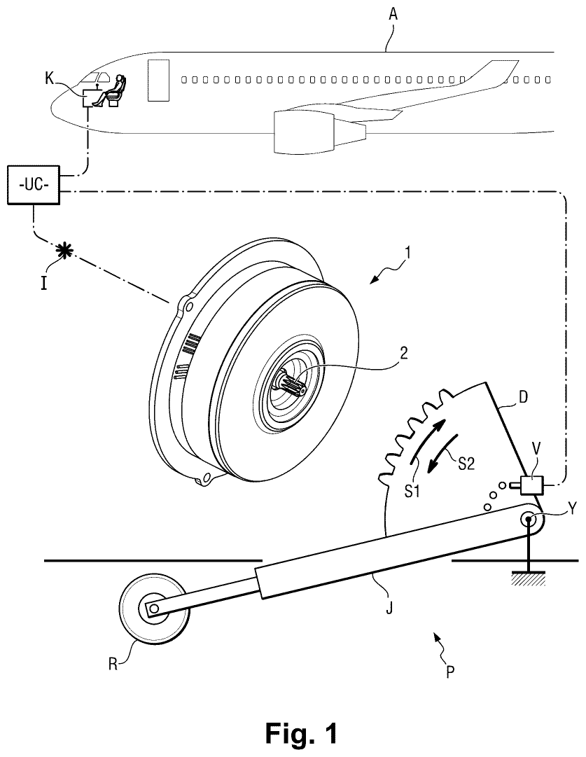

With reference to FIG. 1, the invention applies to an aircraft A comprising main landing gears P that each comprise a strut J having a first end, which is connected to a structure of the aircraft A so as to be pivotable about an axis Y, and a second end that bears wheels R.

The first end of the strut J is provided with a toothed-wheel segment D connected to said first end so as to be rotatable about the axis Y. The toothing of the toothed-wheel segment D meshes with a pinion fitted on an output shaft 2 of an electric motor, which is denoted generally by reference sign 1.

The motor 1 is fastened to the structure of the aircraft and is controlled by a control unit UC from a cockpit K of the aircraft A. An action I controlled by the control unit UC causes the output shaft 2 of the motor 1, and therefore the toothed-wheel segment D, to rotate in a first direction S1 for deploying the landing gear P or in a second direction S2 for retracting the landing gear P. A controllable lock V holds the toothed-wheel segment D in the deployed or retracted position.

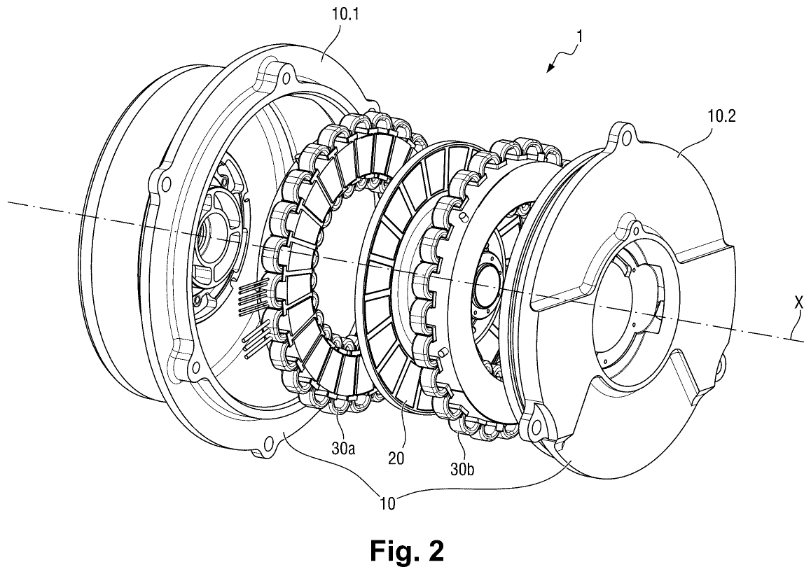

With reference to FIG. 2, the motor 1 comprises a casing 10 that defines a volume inside which there is mounted a rotor 20 extending between a first stator 30a and a second stator 30b. The casing in this case is made in two parts, namely a first part 10.1 and a second part 10.2 that are screwed together.

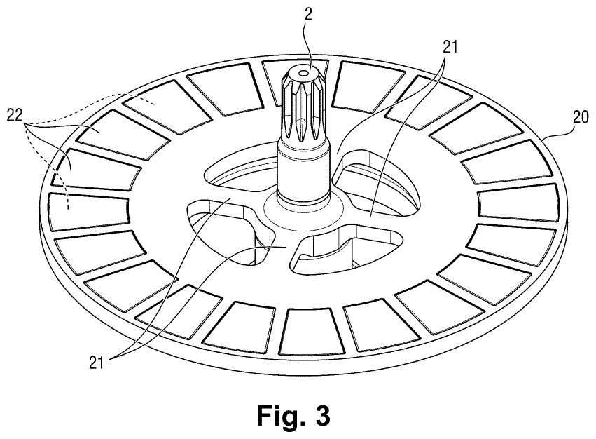

The rotor 20 is generally annular in shape and is fitted so as to be rotatable about an axis X by means of ball bearings (not shown). As shown in FIG. 3, the rotor 20 in this case is connected to the output shaft 2 of the motor 1 by radial arms 21 such that said rotor 20 rotating about the axis X causes said output shaft 2 to rotate about the same axis X. A connection of this kind makes it possible to limit the mass of the assembly formed by the rotor 20 and the output shaft 2, said assembly conventionally being produced as a single piece. The rotor 20 comprises a plurality of permanent magnets 22 which are evenly angularly distributed about the axis X and whose poles alternate. The permanent magnets 22 extend in a radial direction and are made of neodymium in this case.

The first stator 30a is fastened to the first part 10.1 of the casing 10 by means of a first fastening device 40a such that said first stator 30a is fixed in place relative to said first part 10.1. Similarly, the second stator 30b is fastened to the second part 10.2 of the casing 10 by means of a second fastening device 40b such that said second stator 30b is fixed in place relative to said second part 10.2.

In this case, the first stator 30a and the second stator 30b are identical and extend symmetrically on either side of the rotor 20. Here, the first fastening device 40a is identical to the second fastening device 40b. Moreover, only the first stator 30a and the first fastening device 40a will be described.

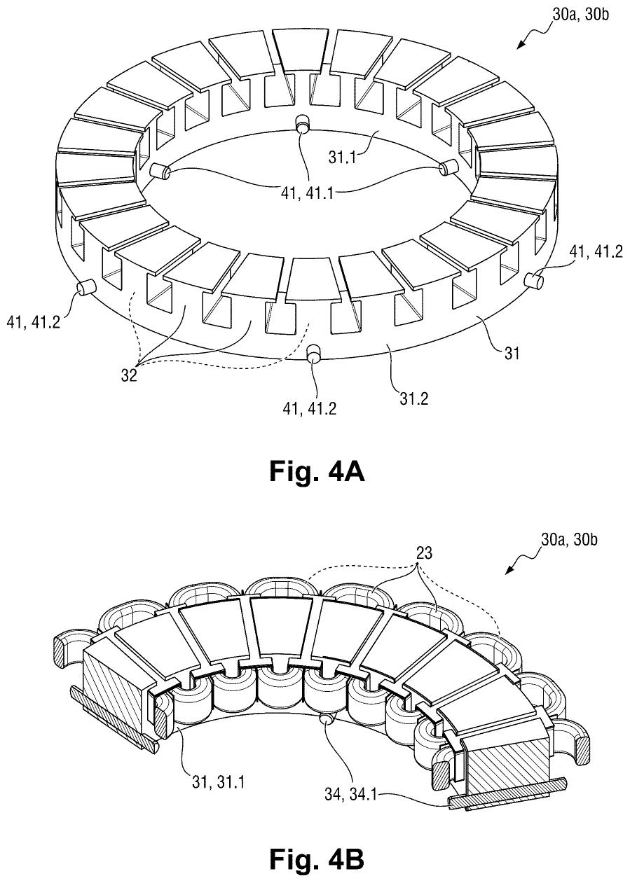

As shown in FIGS. 4A-4B, the first Stator 30a comprises a laminated core forming a ferromagnetic yoke 31 made of soft iron. In this case, the laminated core is produced by winding and is arranged axially. The yoke 31 is generally annular in shape and has a plurality of teeth 32 that extend radially between an inner surface 31.1 and an outer surface 31.2 of the yoke 31, opposite the permanent magnets 21 of the rotor 20. The inner surface 31.1 and the outer surface 31.2 are cylindrical in shape and define an inner circumference and an outer circumference of the yoke 31, respectively. A coil 33 extends around each of the teeth 32 and is connected to the control unit UC so as to form, together with the permanent magnets 21 of the rotor 20, an axial flux motor.

The first fastening device 40a comprises six pins 41, each force-fitted into a through-hole made in the yoke 31 of the first stator 30. The pins 41 each extend in a radial direction of the yoke 31 and are evenly angularly distributed about the axis X. Each of the pins 41 comprises a first end portion 41.1 which projects from the inner surface 31.1 of the yoke 31, and a second end portion 41.2 which is opposite the first end portion 41.1 and projects from the outer surface 31.2 of said yoke 31. The first end portions 41.1 and the second end portions 41.2 form first lugs and second lugs, respectively. In this case, the pins 41 are identical and generally cylindrical in shape.

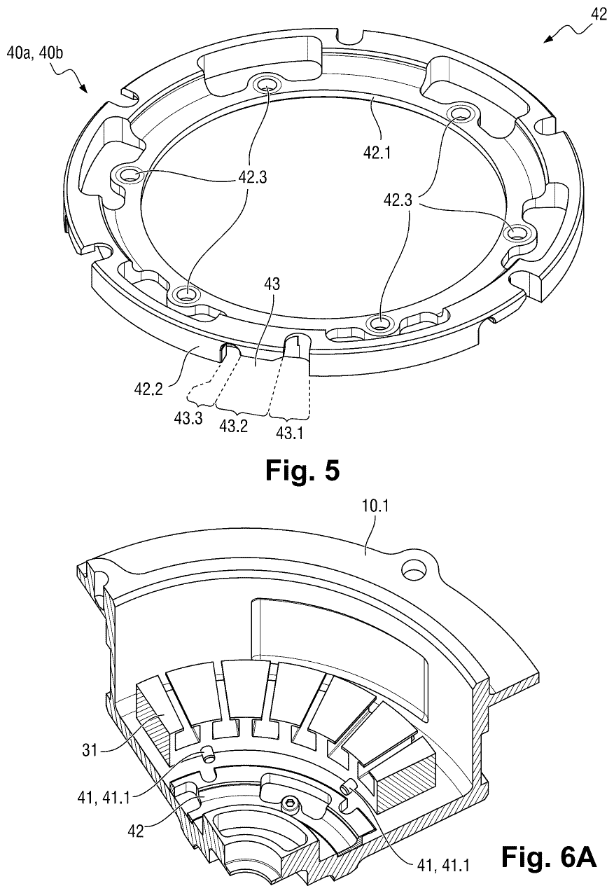

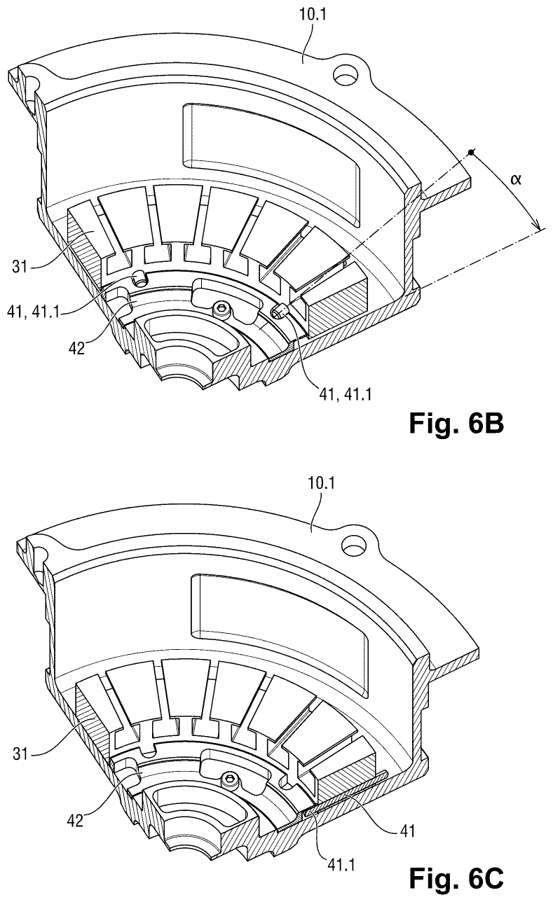

The first fastening device 40a also comprises a plate 42 for receiving the first end portions 41.1 of the pins 34 (FIG. 5). The plate 42 is annular in shape and is mounted on the first part 10.1 of the housing 10. For this purpose, the plate 42 comprises a rear face that interacts with a bottom of the first part 10.1 of the casing 10, and a first, inner cylindrical bearing surface 42.1 that interacts with a corresponding bearing surface arranged in the bottom of said first part 10.1 of the casing 10 in order to centre the plate 42 with respect to the axis of rotation X of the rotor 20. The plate 42 is screwed to the first part 10.1 of the housing 10 by means of screws passing through holes 42.3 made in an inner periphery of the plate 42, such that said plate 42 is fixed in place relative to said first part 10.1 of the casing 10.

The plate 42 also comprises a second, outer cylindrical bearing surface 42.2 that extends opposite the inner surface 31.1 of the first stator 30a.

The plate 42 also comprises six bayonet fastening notches 43 suitable for receiving the first end portions 41.1 of the pins 41. The notches 43 are arranged on an outer periphery of the plate 42 and are evenly angularly distributed about the axis X. In this case, the notches 43 are identical and comprise:
a first section 43.1 for inserting a first end portion 41.1 of a pin 41, said first section extending radially from the second cylindrical bearing surface 42.2 of the plate 42;
a second section 43.2 for guiding the first end portion 41.1, said second section being in communication with the first section 43.1 and extending in a circumferential direction while defining a guide ramp; and
a third section 43.3 for fixing the first end portion 41.1 in place, said third section being in communication with the second section 43.2 and extending axially from the rear face of the plate 42 to form a groove for receiving said first end portion 41.1.

The different steps for fitting the first stator 30a on the first part 10.1 of the casing 10 will now be explained in detail.

First, the plate 42 is inserted in an axial direction into the first part 10.1 of the casing 10 until the first cylindrical bearing surface 42.1 of said plate 42 interacts with the corresponding bearing surface of the bottom of said first part 10.1 of the casing 10 and the plate 42 bears against the bottom. The plate 42 is then screwed to the first part 10.1 of the casing 10 such that said plate 42 is connected to said first part 10.1 of the casing 10 so as to be rotatable about the axis X while remaining axially movable between a close-together position, in which the rear face of the plate 42 bears against the bottom of the first part 10.1 of the casing 10, and a spaced-apart position, in which said rear face is at a distance from said bottom.

The first stator 30a is then in turn inserted in an axial direction into the first part 10.1 of the casing 10, the teeth 32 of said first stator 32a pointing outwards from said first part 10.1 of the casing 10, and the first end portions 41.1 of the pins 41 facing the first sections 43.1 of the notches 43 of the plate 42. Since the first end portions 41.1 of the pins 41 are received in the first sections 43.1 of the notches 43, and the first stator 30a bears against the bottom of the first part 10.1 of the casing 10, said first stator 30a is pivoted by an angle α (equal to 15° in this case) in a predetermined direction adapted so that the first end portions 41.1 of the pins 41 each move from the first section 43.1 of the notch 43 to the third section 43.3 of the notch 43 via the second section 43.2 of the notch 43. Owing to the action of the first end portions 41.1 of the pins 41 on the ramps of the second sections 43.2 of the notch 43, the pivoting of the first stator 30a causes the plate 42 to move from the close-together position to the spaced-apart position.

The plate 42 is then screwed at a predefined torque, which causes the plate 42 to move from the spaced-apart position to the close-together position and causes the first end portions 41.1 of the pins 41 to interact with the grooves in the third sections 43.3 of the notch 43. The first stator 30a is then axially and angularly fixed in place about the axis X by the plate 42, such that said first stator 30a is fixed in place relative to the plate 42 and thus relative to the first part 10.1 of the casing 10. The plate 42 thus forms a flange.

It is noted that arranging the plate 42 in this way in contact with the first stator 30a allows the bending of the pins 41 to be limited.

Similarly, the second fastening device 40b comprises a plate 42 suitable for fixing the second stator 30b in place relative to the second part 10.2 of the housing 10.

It goes without saying that the invention is not limited to the described embodiment but covers any variant falling under the scope of the invention as defined by the claims.

Although the invention here applies to the main landing gears P of the aircraft A, it may also apply to any movable landing gear fitted on an aircraft (front landing gear, central landing gear, etc.).

The number of pins 41 may be less than or greater than six. This depends in particular on the axial forces exerted on the stator 30a, 30b via the permanent magnets 21 of the rotor 20 when the motor 1 is both in operation and at rest.

The pins 41 need not necessarily be evenly distributed about the axis X.

In the described embodiment, the pins 41 need not necessarily project from the outer surface 31.2 of said yoke 31.

Although the plate 42 in this case is arranged to interact with the first end portions 41.1 of the pins 41, it may also be arranged to interact with the second end portions 41.2 of said pins 41.

The pins 41 may be replaced with any element forming lugs that are suitable for bayonet fastening. For example, the lugs may be integral with the yoke 31 of the stator 30a, 30b.

Preferably, the pins 41, as shown in FIG. 4A, extend away from the teeth 32 of the yoke 31 in order to limit the magnetic saturation of said yoke 31 generated by the holes receiving said pins 41. Another way to limit this magnetic saturation is to make the pins 41 out of a magnetic material, for example out of 15-5PH or 17-4PH stainless steel.

Although the device 40a, 40b for fastening the stator 30a, 30b in this case comprises a single flange (formed by the plate 42) for fixing the set of pins 41 in place, it may also comprise as many flanges as there are pins 41.

The notches 43 made in the plate 42 may have a simple rectilinear shape, with a single blind section for receiving the end portion 41.1 of the pin 41 and locking it against translation and against rotation (the plate 42 being placed in the first part 10.1 of the casing 10 after the stator 30a).

Instead of the plate 42, the fastening device 40a, 40b may comprise screws that pass through the casing and are screwed into threads provided along the axis X in the first end portions 41.1 of the pins 41 so as to lock the stator 30a along and around the axis X.

1. An electric motor, comprising:
a casing inside which there is mounted;
at least one stator; and
a rotor that can rotate about an axis opposite the stator, the rotor having magnetic poles and the stator comprising a ferromagnetic yoke that bears windings arranged to produce, together with the magnetic poles of the rotor, an axial flux electric motor,
wherein the stator is fixed in place relative to the casing by a fastening device which includes:
lugs projecting radially from a surface of the yoke; and
at least one fastening element that is fastened to the casing and configured to interact with the lugs to lock the stator along and around the axis.

2. The electric motor according to claim 1, wherein the lugs project from an inner surface of the yoke.

3. The electric motor according to claim 1, further comprising pins which are inserted into holes formed in the yoke, wherein the pins have an end portion projecting radially from the surface of the yoke to form the lugs.

4. The electric motor according to claim 1, wherein the lugs are evenly angularly distributed about the axis.

5. The electric motor according to claim 1, wherein the yoke of the stator is generally annular in shape and comprises a plurality of teeth around which the windings are wound, the lugs extending away from the teeth.

6. The electric motor according to claim 1, wherein the fastening device comprises a single fastening element having a flange which includes a plate having bayonet fastening notches suitable for receiving the lugs.

7. The electric motor according to claim 6, wherein the plate comprises an outer cylindrical bearing surface arranged to interact with a corresponding bearing surface formed by an inner surface of the stator.

8. The electric motor according to claim 1, wherein the fastening device comprises a plurality of fastening elements, each fastening element comprising a screw which passes through the casing and is screwed into a thread provided in one of the lugs along the axis.

9. The electric motor according to claim 1, further comprising two identical stators extending symmetrically on either side of the rotor.

10. An aircraft comprising at least one landing gear which includes a strut pivotably mounted on a structure of the aircraft, wherein the strut is pivotable between a deployed position and a retracted position by an electric motor according to claim 1.
